(19) United States
(12) Patent Application Publication
(10) Pub. No.: US 2014/0282022 A1
(43) Pub. Date: Sep. 18, 2014

(54) CONFIGURING DEVICE LAYOUTS

(71) Applicant: Keisuke Shingu, San Francisco, CA (US)

(72) Inventor: Keisuke Shingu, San Francisco, CA (US)

(73) Assignee: Miselu Inc, San Francisco, CA (US)

(21) Appl. No.: 13/842,690

(22) Filed: Mar. 15, 2013

(51) Int. Cl. H04L 12/24

(52) U.S. Cl. CPC H04L 41/22
USPC 715/735

(57) ABSTRACT

Embodiments generally relate to processing music. In one embodiment, a method includes receiving a layout configuration having nodes. The method also includes receiving an information flow configuration that indicates information flow among the nodes. The method also includes associating devices with the nodes. The method also includes causing information to flow among the devices based on the information flow configuration.

### BACKGROUND

The creation of music is a popular activity enjoyed by many people. Various devices may be used to enable a user to create music. For example, a user may connect a musical instrument such as a piano keyboard to a computer system. This enables the user to create music using the keyboard and record the music on the computer system. The user may connect various other devices such as speakers to the keyboard and/or computer system. Such devices are typically connected together using wires.

### SUMMARY

Embodiments generally relate to processing music. In one embodiment, a method includes receiving a layout configuration having nodes. The method also includes receiving an information flow configuration that indicates information flow among the nodes. The method also includes associating devices with the nodes. The method also includes causing information to flow among the devices based on the information flow configuration.

In another embodiment, a computer-readable storage medium carries one or more sequences of instructions thereon. The instructions when executed by a processor cause the processor to perform operations including receiving a layout configuration having nodes. The instructions further cause the processor to perform operations including receiving an information flow configuration that indicates information flow among the nodes. The instructions further cause the processor to perform operations including associating devices with the nodes. The instructions further cause the processor to perform operations including causing information to flow among the devices based on the information flow configuration.

In another embodiment, a system includes one or more processors, and includes logic encoded in one or more tangible media for execution by the one or more processors. When executed, the logic is operable to perform operations including receiving a layout configuration having nodes. The logic is further operable to perform operations including receiving an information flow configuration that indicates information flow among the nodes. The logic is further operable to perform operations including associating devices with the nodes. The logic is further operable to perform operations including causing information to flow among the devices based on the information flow configuration.

### BRIEF DESCRIPTION OF THE DRAWINGS

FIG. 1 is a block diagram of an example system, which may be used to implement the embodiments described herein.

FIG. 2 illustrates an example simplified flow diagram for processing music, according to some embodiments.

FIG. 3A illustrates an example node layout configuration, according to some embodiments.

FIG. 3B illustrates an example a relative physical layout of devices, according to some embodiments.

FIG. 4 illustrates an example simplified flow diagram for associating devices with nodes, according to some embodiments.

FIG. 5 illustrates an example device layout configuration, according to some embodiments.

FIG. 6 illustrates an example simplified flow diagram for modifying an information flow configuration, according to some embodiments.

FIG. 7 illustrates an example relative physical layout of devices, according to some embodiments.

FIG. 8 illustrates an example device layout configuration, according to some embodiments.

FIG. 9A illustrates an example node layout configuration, according to some embodiments.

FIG. 9B illustrates an example a relative physical layout of devices, according to some embodiments.

FIG. 10A illustrates an example device layout configuration, according to some embodiments.

FIG. 10B illustrates an example device layout configuration, according to some embodiments.

FIG. 11A illustrates an example node layout configuration, according to some embodiments.

FIG. 11B illustrates an example node layout configuration, according to some embodiments.

FIG. 12A illustrates an example device layout configuration, according to some embodiments.

FIG. 12B illustrates an example device layout configuration, according to some embodiments.

FIG. 13A illustrates an example node layout configuration, according to some embodiments.

FIG. 13B illustrates an example node layout configuration, according to some embodiments.

FIG. 14A illustrates an example device layout configuration, according to some embodiments.

FIG. 14B illustrates an example device layout configuration, according to some embodiments.

### DETAILED DESCRIPTION OF EMBODIMENTS

Embodiments described herein enable a user to process music by conveniently connecting various devices together in a network. In some embodiments, a system receives a layout configuration, where the layout configuration has nodes that represent relative physical positions. For example, the node may represent physical positions of devices used to create and process music. Such devices may include, for example, one or more musical instruments (e.g., electronic keyboard, guitar, etc.), one or more sound effects devices (e.g., distortion, reverb, etc.), and any other device for music generation and processing. In some implementations, a user may first provide the layout configuration to the system as desired and then layout the devices in accordance with the layout configuration. Conversely, in some implementations, a user may first layout the devices as desired and then provide the layout configuration to the system in accordance with the layout of the devices.

The system then receives an information flow configuration that indicates information flow among the nodes. The system also displays the layout configuration and the information flow configuration to the user. The system then associates the devices with the plurality of nodes, where the associating is based on relative physical positions of the devices. The system then causes information to flow among the devices based on the information flow configuration. In various implementations, the system detects changes to relative physical positions of the devices, and re-associates the devices with the nodes based on the detecting of the changes.

As a result, the user has the experience of creating and processing music using various devices. Embodiments also enable the user to conveniently reconfigure the devices and information flow among the devices.

FIG. 1 is a block diagram of an example system 100, which may be used to implement the embodiments described herein. In some embodiments, computer system 100 may include a processor 102, an operating system 104, a memory 106, a music application 108, a network connection 110, a microphone 112, a touchscreen 114, and a speaker 116. For ease of illustration, the blocks shown in FIG. 1 may each represent multiple units. In other embodiments, system 100 may not have all of the components shown and/or may have other elements including other types of elements instead of, or in addition to, those shown herein.

Music application 108 may be stored on memory 106 or on any other suitable storage location or computer-readable medium. Music application 108 provides instructions that enable processor 102 to perform the functions described herein. In various embodiments, music application 108 may run on any electronic device including smart phones, tablets, computers, etc.

In various embodiments, touchscreen 114 may include any suitable interactive display surface or electronic visual display that can detect the presence and location of a touch within the display area. Touchscreen 114 may support touching the display with a finger or hand, or any suitable passive object, such as a stylus. Any suitable display technology (e.g., liquid crystal display (LCD), light emitting diode (LED), etc.) can be employed in touchscreen 114. In addition, touchscreen 114 in particular embodiments may utilize any type of touch detecting technology (e.g., resistive, surface acoustic wave (SAW) technology that uses ultrasonic waves that pass over the touchscreen panel, a capacitive touchscreen with an insulator, such as glass, coated with a transparent conductor, such as indium tin oxide (ITO), surface capacitance, mutual capacitance, self-capacitance, projected capacitive touch (PCT) technology, infrared touchscreen technology, optical imaging, dispersive signal technology, acoustic pulse recognition, etc.).

In various embodiments, processor 102 may be any suitable processor or controller (e.g., a central processing unit (CPU), a general-purpose microprocessor, a microcontroller, a microprocessor, etc.). Further, operating system 104 may be any suitable operating system (OS), or mobile OS/platform, and may be utilized to manage operation of processor 102, as well as execution of various application software. Examples of operating systems include Android from Google, iPhone OS (iOS), Berkeley software distribution (BSD), Linux, Mac OS X, Microsoft Windows, and UNIX.

In various embodiments, memory 106 may be used for instruction and/or data memory, as well as to store music and/or video files created on or downloaded to system 100. Memory 106 may be implemented in one or more of any number of suitable types of memory (e.g., static random access memory (SRAM), dynamic RAM (DRAM), electrically erasable programmable read-only memory (EEPROM), etc.). Memory 106 may also include or be combined with removable memory, such as memory sticks (e.g., using flash memory), storage discs (e.g., compact discs, digital video discs (DVDs), Blu-ray discs, etc.), and the like. Interfaces to memory 106 for such removable memory may include a universal serial bus (USB), and may be implemented through a separate connection and/or via network connection 110.

In various embodiments, network connection 110 may be used to connect other devices and/or instruments to system 100. For example, network connection 110 can be used for wireless connectivity (e.g., Wi-Fi, Bluetooth, etc.) to the Internet (e.g., navigable via touchscreen 114), or to another device. Network connection 110 may represent various types of connection ports to accommodate corresponding devices or types of connections. For example, additional speakers (e.g., Jawbone wireless speakers, or directly connected speakers) can be added via network connection 110. Also, headphones via the headphone jack can also be added directly, or via wireless interface. Network connection 110 can also include a USB interface to connect with any USB-based device.

In various embodiments, network connection 110 may also allow for connection to the Internet to enable processor 102 to send and receive music over the Internet. As described in more detail below, in some embodiments, processor 102 may generate various instrument sounds coupled together to provide music over a common stream via network connection 110.

In various embodiments, speaker 116 may be used to play sounds and melodies generated by processor 102. Speaker 116 may also be supplemented with additional external speakers connected via network connection 110, or multiplexed with such external speakers or headphones.

FIG. 2 illustrates an example simplified flow diagram for processing music, according to some embodiments. Referring to both FIGS. 1 and 2, a method is initiated in block 202 where processor 102 receives a layout configuration having nodes. In various implementations, the nodes represent relative physical positions. For example, as described in more detail below, the nodes may represent the relative physical positions of devices placed on one or more surfaces (e.g., floor, table, etc.). Such devices may include, for example, one or more musical instruments (e.g., electronic keyboard, guitar, etc.), one or more sound effects devices (e.g., distortion, reverb, etc.), and any other device for generation and processing of music.

FIG. 3A illustrates an example node layout configuration 300, according to some embodiments. As shown, node layout configuration 300 includes nodes 302, 304, 306, and 308. As indicated above, the nodes represent physical positions. For example, node 302 is positioned at one end, and node 308 is positioned at the other end. Node 304 is positioned between nodes 302 and 306, and node 306 is positioned between nodes 304 and 308.

FIG. 3B illustrates an example a relative physical layout 310 of actual musical and hardware devices, according to some embodiments. As shown, relative physical layout 310 includes the positioning of actual devices 312, 314, 316, and 318, and may include any device used for creating and processing of music, and capable of communicating with other devices. As shown in this particular implementation, device 312 represents a musical instrument (e.g., an electronic keyboard), devices 314 and 316 represent computers, and device 318 represents a music control panel.

For ease of illustration, only four nodes and four devices are shown in FIGS. 3A and 3B. Also, the layout configuration is a simple linear series of nodes and devices. There could be any number of nodes devices and any number configuration patterns, as illustrated in example implementations described below. Furthermore, for ease of illustration, devices 312, 314, 316, and 318 are not limited to the types of devices described and may be any type of device used for creating and processing music (e.g., distortion devices, volume devices, amplification devices, mixers, foot pedals, etc.). Additionally, nodes and devices may receive multiple inputs and/or may feed to multiple outputs.

Referring still to FIGS. 3A and 3B, in some implementations, a user may first provide the layout configuration to the system as desired, and then layout the devices in accordance with the layout configuration. Conversely, in some implementations, a user may first layout the devices as desired, and then provide the layout configuration to the system in accordance with the layout of the devices. Example layout configurations are described in detail below.

In various implementations, the user may use any suitable configuration tool to configure node layout configuration 300, such as the number of nodes and their relative positions. In various implementations, the user may use any suitable user interface including gestures, mouse inputs, key inputs to provide node layout configuration 300 and selections. In some implementations, processor 102 may enable the user to select a node (e.g., via predetermined gesture, click of a mouse or key, touch of a touchscreen, etc.). Processor 102 then enables the user to drag nodes around the screen to desired positions. Once the user is satisfied with node layout configuration 300, processor 102 may fix/lock node layout configuration 300.

In block 204, processor 102 receives an information flow configuration that indicates information flow among the nodes. In some implementations, processor 102 may enable the user to indicate information flow configuration in a variety of ways. In some implementations, processor 102 may enable the user to drag one node to another node to indication a direction of information flow. For example, the user may drag node 302 toward node 304 to touch or overlay node 304. This establishes a direction of information flow from node 302 to node 304. Similarly, the user may drag node 304 toward node 306 to touch or overlay node 306. This establishes a direction of information flow from node 304 to node 306. Similarly, the user may drag node 306 toward node 308 to touch or overlay node 308. This establishes a direction of information flow from node 306 to node 308. This is one example of establishing an information flow configuration, and the particular method for establishing an information flow configuration will depend on the particular implementation.

In some implementations, processor 102 may cause the resulting information flow configuration to be displayed to the user by adding information flow indicators to the layout configuration. The information flow indicators indicate direction/flow of information among nodes. For example, referring to FIG. 3A, arrows 322, 324, and 326 indicate the direction/flow of information among nodes 302, 304, 306, and 308, respectively. Specifically, arrow 322 indicates the flow of information from node 302 to node 304. Arrow 324 indicates the flow of information from node 304 to node 306. Arrow 326 indicates the flow of information from node 306 to node 308. In other words, referring to both FIGS. 3A and 3B together, the information flows from device 312 to device 314 to device 316 to device 318, etc. In some implementations, arrow 328 of FIG. 3A may indicate further processing or an output.

In block 206, processor 102 associates devices with the nodes. In various implementations, processor 102 associates the devices with the nodes based on the relative physical positions of the devices. In other words, processor 102 associates the devices with the nodes depending on how the devices are physically laid out on one or more surfaces. An example method for associating the devices with the nodes is described in detail below in connection with FIG. 4.

In block 208, processor 102 causes information to flow among the devices based on the information flow configuration. Referring again to FIG. 3B, arrows 332, 334, 336, and 338 indicate the flow of information among devices 312, 314, 316, and 318, respectively. Specifically, arrow 332 indicates the flow of information from device 312 to device 314. Arrow 334 indicates the flow of information from device 314 to device 316. Arrow 336 indicates the flow of information from device 316 to device 318. In some implementations, arrow 338 of FIG. 3B may indicate further processing or an output. In various implementations, the devices may be paired or coupled using any suitable methods and techniques. In various implementations, the types of information that is transmitted among devices 312, 314, 316, and 318 may be any type of information such as audio streams.

FIG. 4 illustrates an example simplified flow diagram for associating devices with nodes, according to some embodiments. In some implementations, a method is initiated in block 402 where processor 102 detects the devices. In various implementations, processor 102 may detect any one or more signals transmitted by each of devices 312, 314, 316, and 318. In various implementations, such signals may include any type of signals transmitted by each of devices 312, 314, 316, and 318, such as Bluetooth, Wi-Fi, etc.

In block 404, processor 102 determines the relative physical positions of the devices. In various implementations, processor 102 may utilize any suitable method, algorithm, and/or technology to determine the relative physical positions of the devices. For example, processor 102 may measure and determine a signal strength from a signal transmitted by each of devices 312, 314, 316, and 318. In some implementations, processor 102 may utilize any suitable triangulation method to determine relative physical positions of devices 312, 314, 316, and 318.

In block 406, processor 102 maps each device to a node based on the relative physical positions of the devices. As indicated above, processor 102 may fix or lock the layout configuration of the nodes. The user may physically move devices around such that the layout configuration of the devices corresponds to the layout configuration of the nodes. Processor 102 may then map each device to a node.

In block 408, processor 102 associates the plurality of devices with the plurality of nodes based on the mapping. In some implementations, processor 102 determines the device identifications of the devices, where each device identification corresponds to one of the devices. The device identification may be provided by each device as signals are transmitted and/or manually by the user. In some implementations, processor 102 may save the configurations in a musical instrument digital interface (MIDI) midi map, or in a map in accordance with any other suitable standard and/or protocol for communication among electronic musical instruments, computers, and other related devices.

In some implementations, processor 102 may enable the user to designate a hub node or core node. As such, the device that is mapped to/associated with the core node becomes the designated core device, where system 102 determines the positions of the other devices relative to the core device. While any give device may be the core device, in some implementations, the core device may be one having a display screen or the largest display screen. In some implementations, the core device may host system 100 and/or may display the user interface that enables the user to configure the nodes and devices, the information flows, as well as display the various configurations to the user.

FIG. 5 illustrates an example virtual device layout configuration 500, according to some embodiments. As shown, virtual device layout configuration 500 includes virtual devices 512, 514, 516, and 518. In various implementations, the virtual device layout configuration (e.g., virtual device layout configuration 500 of FIG. 5) represents/corresponds to the actual relative physical layout (e.g., relative physical layout 310 of FIG. 3B). For example, virtual devices 512, 514, 516, and 518 correspond to/represent actual devices 312, 314, 316, and 318 of FIG. 3B, respectively.

In various implementations, processor 102 causes one or more of the node layout configuration (e.g., node layout configuration 300 of FIG. 3A), the information flow configuration (e.g., node layout configuration 300 including flow direction indicators of FIG. 3A), and the device layout configuration (e.g., device layout configuration 500 of FIG. 5) to be displayed to the user. For example, processor 102 may cause images such as those shown in FIGS. 3A and 5 to be displayed to the user on the display of the core device.

FIG. 6 illustrates an example simplified flow diagram for modifying an information flow configuration, according to some embodiments. In some implementations, a method is initiated in block 602 where processor 102 detects changes to relative physical positions of the devices.

FIG. 7 illustrates an example relative physical layout 710 of devices, according to some embodiments. As shown, relative physical layout 710 of devices includes the positioning of devices 312, 314, 316, and 318. In various implementations, the user may move devices around to different positions in real space and in real-time. Comparing the relative physical layouts 310 and 710, device 318 is repositioned between devices 312 and 314.

In various implementations, processor 102 may detect such changes based on any suitable method, algorithm, and/or technology that determines the physical locations of devices. In some implementations, processor 102 may determine the relative physical layout 710 at predetermined periodic time periods (e.g., every S seconds). If/when processor 102 detects a change to the relative physical layout, processor 102 may then determine the new relative physical layout.

Based on such changes, in block 604, processor 102 then re-associates the devices with the plurality of nodes based the changes (e.g., based on the new relative physical positions of the devices).

In block 606, processor 102 causes information to flow among the devices based on the changes and the information flow configuration.

FIG. 8 illustrates an example device layout configuration 800, according to some embodiments. As shown, device layout configuration 800 includes virtual devices 812, 818, 814, and 816. In various implementations, the device layout configuration (e.g., device layout configuration 800 of FIG. 8) represents the actually relative physical layout (e.g., relative physical layout 710 of FIG. 7). For example, virtual devices 812, 818, 814, and 816 correspond to/represent actual devices 312, 318, 314, and 316 of FIG. 7 in the respective sequences shown.

Referring to FIGS. 3A, 3B, and 7 together, while node layout configuration 300 may be locked, the relative physical layout 310 changes to relative physical layout 710. Accordingly, the flow of information changes such that information flows from device 312 to device 318 to device 314 to device 316, etc.

A benefit of the detection of changes to the relative physical positions and re-association of the devices is that the user (e.g., a musician, disk jockey, etc.) may intentionally change the information in real-time while performing. For example, if one of the devices is a guitar, the user may move to different parts of the stage to different positions relative to other devices and change the information flow (e.g., the order in which the signal is routed through the devices).

FIG. 9A illustrates an example node layout configuration 900, according to some embodiments. As shown, node layout configuration 900 includes nodes 902, 904, 906, and 908. As indicated above, the nodes represent physical positions, as shown.

In various implementations, active or reactivated nodes may be represented by a square or any other shape or marking. Inactive or deactivated nodes may be represented by a circle or any other shape or marking distinguishing such nodes from active or reactivated nodes, as shown in FIG. 9A. For example, the circles of FIG. 9A (no reference numbers) represent inactive/deactivated nodes, and the squares with reference numbers represent active nodes. These example conventions also apply to the other node layout configurations described herein.

FIG. 9B illustrates an example relative physical layout 910 of the actual devices, according to some embodiments. As shown, relative physical layout 910 includes the positioning of devices 312, 314, 316, and 318. As shown in this particular implementation, and for ease of illustration, devices 312, 314, 316, and 318 are the same as those shown in FIG. 3B. The difference between FIGS. 3B and 9B is that the relative physical layouts of 310 and 910 are different. Also note that while node layout configuration 300 of FIG. 3A and node layout configuration 900 of FIG. 9A are different, the information flow configuration indicated by arrows 322, 324, 326, and 328 of FIG. 3A are similar to the information flow configuration indicated by arrows 922, 924, 926, and 928 of FIG. 9A. Accordingly, with the various implementations described herein, information flows among devices 312, 314, 316, and 318 similarly in both relative physical layouts 310 and 910. For example, the flows from device 312 to device 314 to device 316 to device 318, etc., are similar in both instances. Referring to FIG. 9A, in some implementations, arrow 928 of FIG. 9A may indicate further processing or an output.

FIG. 10A illustrates an example device layout configuration 1000, according to some embodiments. As shown, device layout configuration 1000 includes virtual devices 1012, 1014, 1016, and 1018. As shown, device layout configuration 1000 of FIG. 10A represents the actual relative physical layout 910 of FIG. 9B. For example, virtual devices 1012, 1014, 1016, and 1018 correspond to/represent actual devices 312, 314, 316, and 318 of FIG. 9B in the respective sequences shown.

FIG. 10B illustrates an example device layout configuration 1050, according to some embodiments. As shown, device layout configuration 1050 includes virtual devices 1012, 1016, 1014, and 1018. The difference between device layout configurations 1000 and 1050, is that virtual devices 1014 and 1016 are swapped (resulting from actual devices 314 and 316 being swapped). For ease of illustration, the relative physical layout for the pre-swap layout is not shown. In various implementations, processor 102 may cause node layout configuration 900, device layout configurations 1000 and subsequently device layout configuration 1050 to be displayed to the user.

Referring to FIGS. 9A, 9B, 10A, and 10B together, while node layout configuration 900 may be locked, the relative physical layout 910 will be changed (e.g., by the user). Hence, device layout configuration 1000 changes to device layout configuration 1050. Accordingly, the flow of information changes such that information flows from device 312 to device 316 to device 314 to device 318, etc.

As described in detail below in connection with FIGS. 11A, 11B, 12A, and 12B, in some implementations, processor 102 enables the user to modify the node layout configuration in order to change the information flow among the actual devices.

FIG. 11A illustrates an example node layout configuration 1100, according to some embodiments. As shown, node layout configuration 1100 includes active nodes 1102, 1104, 1106, and 1108. As indicated above, the nodes represent physical positions, as shown.

FIG. 11B illustrates an example node layout configuration 1150, according to some embodiments. As shown, node layout configuration 1150 includes nodes 1102, 1104, and 1108. As indicated above, the nodes represent physical positions, as shown.

Referring to both FIGS. 11A and 11B together, the difference is that node 1106 shown in FIG. 11A has been deactivated. In some implementations, processor 102 may deactivate (or activate or reactivate) a given node upon receiving an indication from the user. In some implementations, the indication to deactivate a given node may be received from the user (e.g., gesture, mouse click, key entry, etc.). In some implementations, the indication to deactivate a given node may be the user physically removing an actual device from the set of devices (e.g., turning the device off, moving the device out of range, etc.).

FIG. 12A illustrates an example device layout configuration 1200, according to some embodiments. As shown, device layout configuration 1200 includes virtual devices 1212, 1214, 1216, and 1218. As indicated above, device layout configuration 1200 of FIG. 12A represents actual devices. For ease of illustration, the corresponding relative physical layout is not shown.

FIG. 12B illustrates an example device layout configuration 1250, according to some embodiments. As shown, device layout configuration 1250 includes virtual devices 1212, 1214, and 1218. The difference between device layout configurations 1200 and 1250, is that virtual device 1216 is removed (resulting from the actual device corresponding to virtual device 1216 being removed). In various implementations, processor 102 may cause node layout configurations 1100 and 1150, and device layout configurations 1200 and 1250 to be displayed to the user.

Referring to FIGS. 9A, 11A, 11B, 12A, and 12B together, node layout configuration 900 may be unlocked and changed, and the relative physical layout may or may not change. Hence, device layout configuration 1200 may change to device layout configuration 1250. Accordingly, the flow of information changes such that information flows from device to device based on the new node layout configuration (or as indicated in relative physical layout 1250).

As described in detail below in connection with FIGS. 13A, 13B, 14A, and 14B, in some implementations, processor 102 enables the user to modify the node layout configuration in order to change the information flow among the actual devices.

FIG. 13A illustrates an example node layout configuration 1300, according to some embodiments. As shown, node layout configuration 1300 includes nodes 1302, 1304, 1306, 1308, and 1314. As indicated above, the nodes represent physical positions, as shown.

FIG. 13B illustrates an example node layout configuration 1350, according to some embodiments. As shown, node layout configuration 1350 includes nodes 1302, 1304, 1308, 1310, 1312, 1314, and 1316. As indicated above, the nodes represent physical positions, as shown.

Referring to both FIGS. 13A and 13B together, the difference is that node 1306 shown in FIG. 13A has been deactivated. Also, nodes 1310, 1312, and 1316 shown in FIG. 13B have been activated. As indicated above, in some implementations, processor 102 may deactivate, activate or reactivate given nodes upon receiving indications from the user. In some implementations, the indications to deactivate activate, and/or reactivate given nodes may be commands received from the user (e.g., gestures, mouse clicks, key entries, etc.). In some implementations, the indications to deactivate, activate, and/or reactivate given nodes may be the user physically removing and/or physically adding one or more actual devices from the set of devices (e.g., turning devices on/off, moving the device in/out of range, etc.).

FIG. 14A illustrates an example device layout configuration 1400, according to some embodiments. As shown, device layout configuration 1400 includes virtual devices 1412, 1414, 1416, 1418, and 1424. As indicated above, device layout configuration 1400 of FIG. 14A represents actual devices. For ease of illustration, the corresponding relative physical layout is not shown.

FIG. 14B illustrates an example device layout configuration 1450, according to some embodiments. As shown, device layout configuration 1450 includes virtual devices 1412, 1414, 1418, 1420, 1422, 1424, and 1426. The difference between device layout configurations 1400 and 1450 is that virtual device 1416 shown in FIG. 14A is removed (resulting from the actual device corresponding to virtual device 1416 being removed. Also, virtual devices 1420, 1422, 1424, and 1426 shown in FIG. 14B are added (resulting from the actual devices corresponding to virtual devices 1410, 1412, and 1416 being added. In various implementations, processor 102 may cause node layout configurations 1300 and 1350, and device layout configurations 1400 and 1450 to be displayed to the user.

Referring to FIGS. 13A, 13B, 14A, and 14B together, node layout configuration 1300 may be unlocked and changed, and the relative physical layout may also be changed. Hence, device layout configuration 1400 may change to device layout configuration 1450. Accordingly, the flow of information changes such that information flows from device to device based on the new node layout configuration (or as indicated in relative physical layout 1450.

Embodiments described herein provide various benefits. For example, embodiments enable professional and non-professional musicians to quickly and conveniently create and process music using various devices. Embodiments also enable the user to conveniently reconfigure the devices and information flow among the devices.

Although the description has been described with respect to particular embodiments thereof, these particular embodiments are merely illustrative, and not restrictive. Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method comprising:
receiving a layout configuration having a plurality of nodes;
receiving an information flow configuration that indicates information flow among the nodes;
associating a plurality of devices with the plurality of nodes; and
causing information to flow among the devices based on the information flow configuration.

2. The method of claim 1, wherein the nodes represent relative physical positions.

3. The method of claim 1, further comprising causing the layout configuration and the information flow configuration to be displayed to a user.

4. The method of claim 1, wherein the associating is based on relative physical positions of the devices.

5. The method of claim 1, wherein the associating comprises:
detecting the plurality of devices;
determining relative physical positions of the devices;
mapping each device to a node based on the relative physical positions of the devices; and
associating the plurality of devices with the plurality of nodes based on the mapping.

6. The method of claim 1, further comprising determining a plurality of device identifications, wherein each device identification corresponds to one of the devices.

7. The method of claim 1, further comprising detecting changes to relative physical positions of the devices.

8. The method of claim 1, further comprising:
detecting changes to relative physical positions of the devices; and
re-associating the plurality of devices with the plurality of nodes based on the detecting of the changes.

9. A computer-readable storage medium carrying one or more sequences of instructions thereon, the instructions when executed by a processor cause the processor to perform operations comprising:
receiving a layout configuration having a plurality of nodes;
receiving an information flow configuration that indicates information flow among the nodes;
associating a plurality of devices with the plurality of nodes; and
causing information to flow among the devices based on the information flow configuration.

10. The computer-readable storage medium of claim 9, wherein the nodes represent relative physical positions.

11. The computer-readable storage medium of claim 9, wherein the instructions further cause the processor to perform operations comprising causing the layout configuration and the information flow configuration to be display to a user.

12. The computer-readable storage medium of claim 9, wherein the associating is based on relative physical positions of the devices.

13. The computer-readable storage medium of claim 9, wherein the instructions further cause the processor to perform operations comprising:
detecting the plurality of devices;
determining relative physical positions of the devices;
mapping each device to a node based on the relative physical positions of the devices; and
associating the plurality of devices with the plurality of nodes based on the mapping.

14. The computer-readable storage medium of claim 9, wherein the instructions further cause the processor to perform operations comprising determining a plurality of device identifications, wherein each device identification corresponds to one of the devices.

15. The computer-readable storage medium of claim 9, wherein the instructions further cause the processor to perform operations comprising detecting changes to relative physical positions of the devices.

16. The computer-readable storage medium of claim 9, wherein the instructions further cause the processor to perform operations comprising:
detecting changes to relative physical positions of the devices; and
re-associating the plurality of devices with the plurality of nodes based on the detecting of the changes.

17. A system comprising:
one or more processors; and
logic encoded in one or more tangible media for execution by the one or more processors, and when executed operable to perform operations comprising:
receiving a layout configuration having a plurality of nodes;
receiving an information flow configuration that indicates information flow among the nodes;
associating a plurality of devices with the plurality of nodes; and
causing information to flow among the devices based on the information flow configuration.

18. The system of claim 17, wherein the nodes represent relative physical positions.

19. The system of claim 17, wherein the logic when executed is further operable to perform operations comprising causing the layout configuration and the information flow configuration to be display to a user.

20. The system of claim 17, wherein the logic when executed is further operable to perform operations comprising:
detecting changes to relative physical positions of the devices; and
re-associating the plurality of devices with the plurality of nodes based on the detecting of the changes.
